(19) United States
(12) Patent Application Publication
(10) Pub. No.: US 2016/0103263 A1
(43) Pub. Date: Apr. 14, 2016

(54) LIGHT TRANSMISSION DEVICE WITH INTEGRATION STRUCTURES

(71) Applicant: Google Inc., Mountain View, CA (US)

(72) Inventors: Andrei Kazmierski, Pleasanton, CA (US); Stephen Duane Dorow, San Francisco, CA (US)

(21) Appl. No.: 14/513,103

(22) Filed: Oct. 13, 2014

(51) Int. Cl. F21V 8/00; G02F 1/1335; G02B 3/00

(52) U.S. Cl. CPC G02B 6/0008; G02B 3/0056; G02F 1/133609

(57) ABSTRACT

A display including an architecture for illuminating pixels with light having consistent brightness and/or color. In an embodiment, a light transmission device of a display includes a light integration body comprising a first integration rod portion to mix light from multiple light sources, and to direct at least a portion of the integrated light toward a microlens array of the light transmission device. The microlens array receives and directs the portion of the integrated light from the light transmission unit toward pixels of the display. In another embodiment, the light transmission unit includes a plurality of integration rod portions and a plurality of microlens arrays each coupled to variously direct integrated light from a respective one of the plurality of integration rod portions toward a different respective pixel array of the display.

### BACKGROUND

1. Technical Field

This disclosure relates generally to display technologies, and in particular, to rear projection screens.

2. Background Art

Large wall displays can be prohibitively expensive as the cost to manufacture display panels rises exponentially with monolithic display area. This exponential rise in cost arises from the increased complexity of large monolithic displays, the decrease in yields associated with large displays (a greater number of components must be defect free for large displays), and increased shipping, delivery, and setup costs. Tiling smaller display panels to form larger multi-panel displays can help reduce many of the costs associated with large monolithic displays.

FIGS. 1A and 1B illustrate how tiling multiple smaller, less expensive display panels 100 together can achieve a large multi-panel display 105, which may be used as a large wall display. The individual images displayed by each display panel 100 may constitute a sub-portion of the larger overall composite image collectively displayed by multi-panel display 105. While multi-panel display 105 can reduce costs, visually it has a major drawback. Each display panel 100, includes a bezel 110 around its periphery. Bezel 110 is a mechanical structure that houses pixel region 115 in which the display pixels are disposed. In recent years, manufactures have reduced the thickness of bezel 110 considerably to less than 2 mm. However, even these thin bezel trims are still very noticeable to the naked eye, distract the viewer, and otherwise detract from the overall visual experience.

### BRIEF DESCRIPTION OF THE DRAWINGS

The various embodiments of the present invention are illustrated by way of example, and not by way of limitation, in the figures of the accompanying drawings and in which:

FIGS. 1A and 1B illustrate conventional display panel tiling.

FIG. 2 is a perspective view illustrating functional layers of a rear projection display, in accordance with an embodiment of the disclosure.

FIG. 3A is a cross-sectional view of functional layers of a rear projection display, in accordance with an embodiment of the disclosure.

FIG. 3B illustrates how rear projection displays can be tiled to form larger seamless displays, in accordance with an embodiment of the disclosure.

FIG. 3C illustrates angular brightness uniformity issues associated with rear projections displays illuminated by divergent light, in accordance with embodiments of the disclosure.

FIGS. 4A, 4B each illustrate elements of a respective light transmission device to illuminate pixels of a display according to a corresponding embodiment of the disclosure.

FIG. 5 illustrates elements of a display including a plurality of light transmission devices according to an embodiment of the disclosure.

FIG. 6 illustrates elements of a light transmission device including an array or microlens arrays to illuminate pixels of a display according to an embodiment of the disclosure.

FIG. 7 is an illustration of components of a hardware platform according to an embodiment of the disclosure.

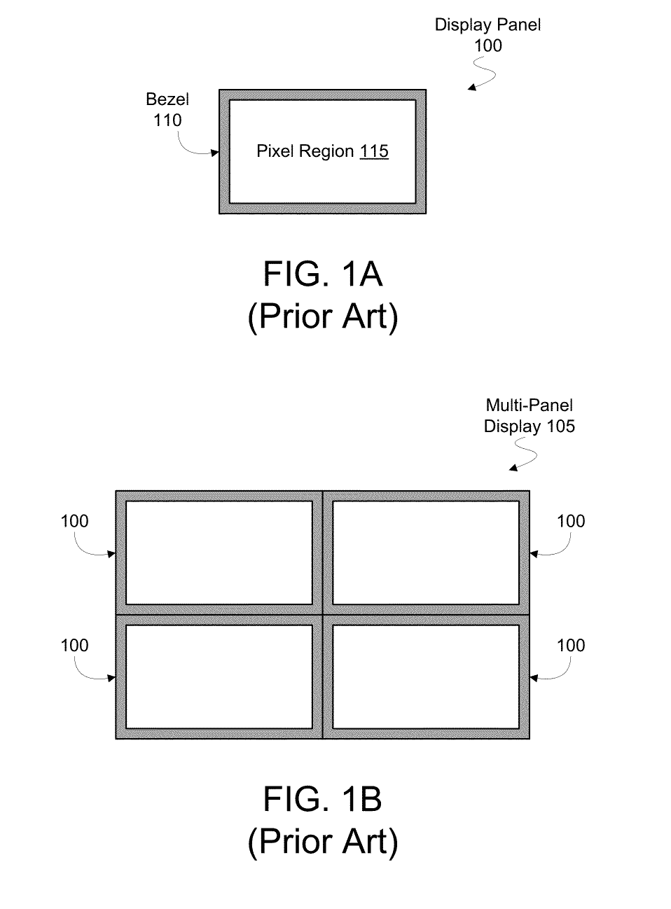

### DETAILED DESCRIPTION

Embodiments of an apparatus, system and method of displaying an image are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

An illumination architecture according to an embodiment comprises multiple light sources, a light integration structure and a microlens array to provide a simple, low profile backlight for a display system. Conventional display architectures are typically limited by the fact that there tends to be noticeable variation between such illumination sources with respect to brightness and/or color. Embodiments discussed herein variously provide mechanisms to reduce the perceptibility of such variation. Certain features of various embodiments are discussed herein with respect to light integration by one illustrative type of tileable rear projection display device. However, such discussion may be extended to additionally or alternatively apply to any of the variety of other types of display devices, according to different embodiments.

Utilizing multiple light sources (such as LEDs) in a close-packed configuration is advantageous for display applications because it eliminates the (expensive, sometimes unavailable) need to purchase a single color and or flux bin in order to maintain consistent color across the visible area of the display. By utilizing light sources from potentially multiple different bins and mixing the light through the integration structures described herein, embodiments variously serve to a) homogenize multiple sources, b) provide redundancy in the case of a single light source failing, c) provide a compact mechanical enclosure to protect fragile light sources from external contact and contamination, d) allow an individual illumination architecture to be scaled into a flexible array size, e) enable local dimming capability in a display system and/or f) help to reduce total power consumption of the light sources within a display.

More particularly, a light transmission device according to an embodiment may comprise a structure, referred to herein as a light integration body, to receive and integrate light from multiple source. A light integration body may be comprised of a single, contiguous body of light transmissive material through which the light from a plurality of illumination sources may propagate. For example, such a body of light transmissive material may be configured for internal reflection of such light off of one or more sidewalls of the body. In another embodiment, a light integration body may comprise a single, contiguous body of material that forms sidewalls of a cavity that extends through the light integration body. The sidewalls of the cavity may be coated with a reflective film, although certain embodiments are not limited in this regard. Such sidewalls may provide for reflection of light to facilitate light integration within the cavity. In such an embodiment, the light integration body may be comprised of light transmissive material or of some other material—e.g., including metal, a translucent plastic or the like.

At least a portion of the light which has been integrated by a light integration body may be received at a microlens array which is disposed at an output end of the light transmission device. Such a microlens array may be helpful or even necessary to generate a virtual source plane from which the integrated light may be projected toward a display layer. Alternatively or in addition, the microlens array may serve as a low-profile mechanism to increase an area of illumination at the output end. In some embodiments, an array (e.g., manifold) of multiple output ends and respective microlens arrays are to variously direct integrated light from the same illumination sources each to a different respective pixel array—e.g. where the pixel arrays are spaced apart from one another in the display device.

High contrast ratio is one feature that may be enhanced according to an embodiment. For example, a 2-dimensional array of light transmission devices—each to integrate light from a different respective group of illumination sources—may allow for the illumination source groups to be independently addressed by control logic. As a result, such control logic may provide flexibility to vary power to any of multiple different regions of a display—e.g., based on local features of different image portions variously represented by such display regions. Certain embodiments may alternatively or additionally provide the benefit of reducing power consumption of the illumination sources, since regions of a displayed image that do not require illumination (dark or shaded areas in an image) may be illuminated with less required power.

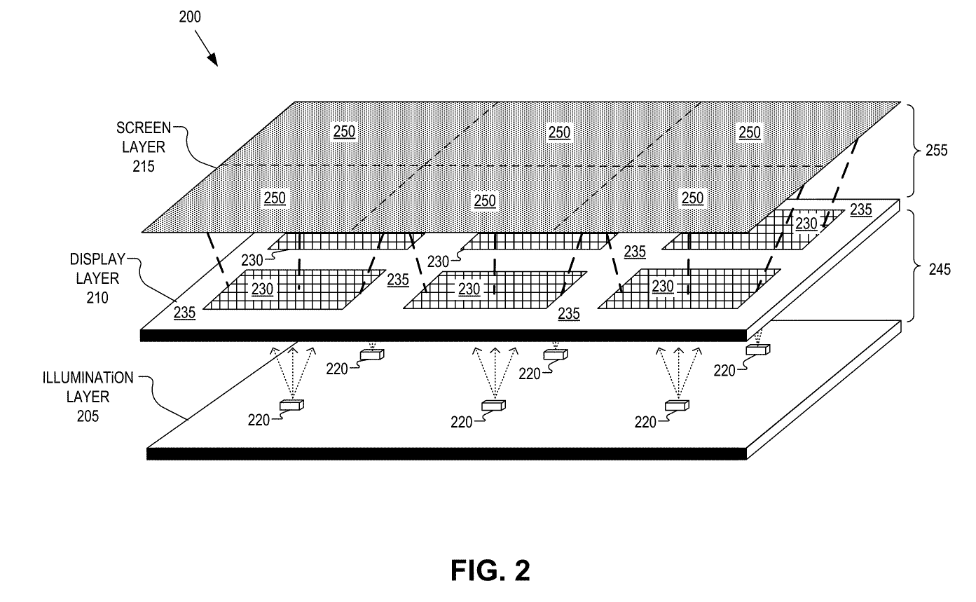

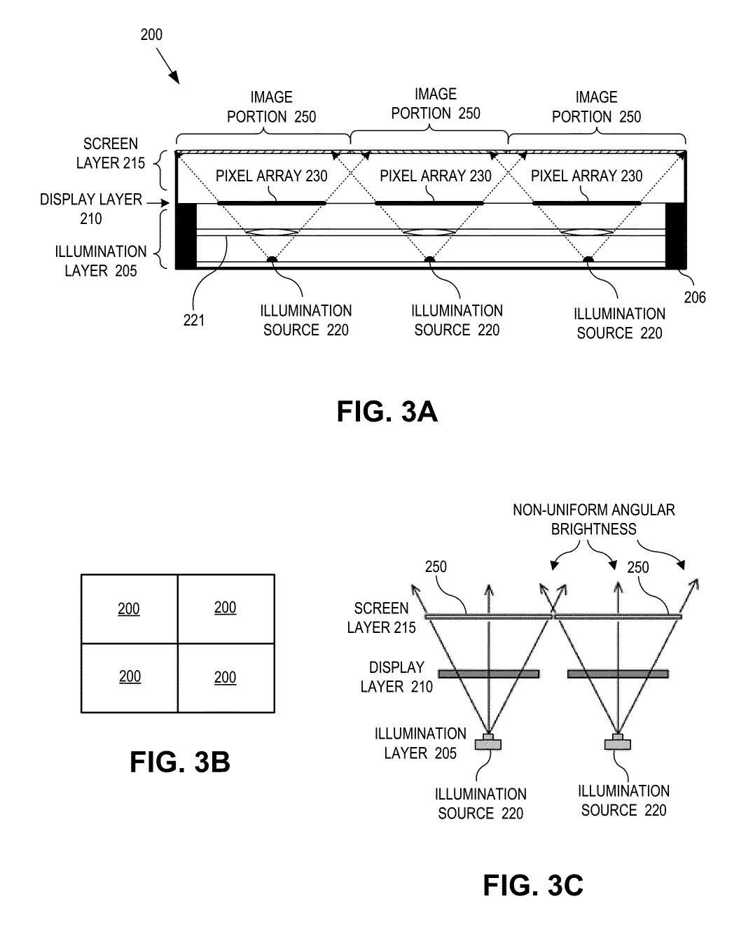

FIGS. 2 and 3A illustrate functional layers of a rear projection display 200, in accordance with an embodiment of the disclosure. FIG. 2 is a perspective view of the layers of display 200 while FIG. 3A is a cross-section view of the same. The illustrated embodiment of display 200 includes an illumination layer 205, a display layer 210, and a screen layer 215. The illustrated embodiment of illumination layer 205 includes an array of illumination sources 220 and a lensing layer 221 (illustrated in FIG. 3A only for clarity). The illustrated embodiment of display layer 210 includes transmissive pixel arrays 230 separated from each other by spacing regions 235. The illustrated embodiment of screen layer 215 is divided into regions for displaying image portions 250 of an overall unified image. Rear projection display 200 is made up of a plurality of pixlets, each including an illumination source 220, transmissive pixel array 230, and a screen region for displaying an image portion 250 all aligned within a column through display 200.

In the illustrated embodiment, each illumination source 220 is aligned under a corresponding pixel array 230 to illuminate a backside of the corresponding pixel array with lamp light. Illumination sources 220 may be implemented as independent light sources (e.g., color or monochromatic LEDs, quantum dots, etc.) that emit light with a defined angular spread or cone to fully illuminate their corresponding transmissive pixel array 230 residing above on display layer 210. The illumination layer 205 and display layer 210 are separated from each other by a fixed distance 245 (e.g., 8 mm). This separation may be achieved using a transparent intermediary (e.g., glass or plastic layers) and may further include one or more lensing layers 221 (including lenses, apertures, beam confiners, etc.) to control or manipulate the angular extent and cross-sectional shape of the lamp light emitted from illumination sources 220. In one embodiment, an illumination controller may be coupled to illumination sources 220 to control their illumination intensity. Illumination layer 205 may include a substrate upon which illumination sources 220 are disposed.

Transmissive pixel arrays 230 are disposed on the display layer 210 and each includes an array of transmissive pixels (e.g., 100 pixels by 100 pixels). In one embodiment, the transmissive pixels may be implemented as backlit liquid crystal pixels. Each transmissive pixel array 230 is an independent display array that is separated from adjacent transmissive pixel arrays 230 by spacing regions 235 on display layer 210. The internal spacing regions 235 that separate adjacent pixel arrays 230 from each other may be twice the width as the perimeter spacing regions 235 that separate a given pixel array 230 from an outer edge of display layer 210. In one embodiment, the internal spacing regions 235 have a width of 4 mm while the perimeter spacing regions 235 have a width of 2 mm. Of course, other dimensions may be implemented.

As illustrated, transmissive pixel arrays 230 are spaced across display layer 210 in a matrix with spacing regions 235 separating each transmissive pixel array 230. In one embodiment, transmissive pixel arrays 230 each represent a separate and independent array of display pixels (e.g., backlit LCD pixels). Spacing region 235 are significantly larger than the inter-pixel separation between pixels of a given transmissive pixel array 230. Spacing regions 235 provide improved flexibility for routing signal lines or the inclusion of additional circuitry, such as a display controller. Spacing regions 235 that reside along the exterior perimeter of display layer 210 also provide space for the bezel trim 206 of display 200. Bezel trim 206 operates as the sides of the housing for display 200. The spacing regions 235 that reside along the exterior perimeter also provide space for power and/or communication ports.

Although FIG. 2 illustrates display layer 210 as including six transmissive pixel arrays 230 arranged into two rows and three columns, it should be appreciated that various implementations of display 200 may include more or less transmissive pixel arrays 230 organized into differing combinations of rows and columns. As such, in embodiments having a one-to-one ratio of illumination sources 220 to transmissive pixel arrays 230, the number and layout of illumination sources 220 on illumination layer 205 may also vary. While FIG. 2 does not illustrate intervening layers between the three illustrated layers for the sake of clarity, it should be appreciated that embodiments may include various intervening optical or structural sub-layers, such as lens arrays, transparent substrates to provide mechanical rigidity and optical offsets, protective layers, or otherwise. Further details of the sub-layers of various embodiments of screen layer 215 are discussed below.

Transmissive pixel arrays 230 are switched under control of a display controller to modulate the lamp light and project image portions 250 onto a backside of screen layer 215. In various embodiments, screen layer 215 includes matte material (or other diffusing material suitable for rear projection) that is disposed on a transparent substrate providing mechanical support. Image portions 250 collectively blend together on screen layer 215 to present a unified image to a viewer from the viewing side of screen layer 215 that is substantially without seams. In other words, the images created by transmissive pixel arrays 230 are magnified as they are projected across separation 255 (e.g., 2 mm) between display layer 210 and screen layer 215. The image portions 250 are magnified enough to extend over and cover spacing regions 235 forming a seamless unified image. The magnification factor is dependent upon separation 255 and the angular spread of the lamp light emitted by illumination sources 220. In one embodiment, image portions 250 are magnified by a factor of approximately 1.5. Not only does the unified image cover the internal spacing regions 235, but also covers the perimeter spacing regions 235. As such, display 200 may be positioned adjacent to other display tiles 200 and communicatively interlinked to form larger composite seamless displays, in which case the unified image generated by a single display tile becomes a sub-portion of a multi-tile unified image (e.g., see FIG. 3B).

In a tiled rear-projection architecture, such as the one illustrated in FIGS. 2 and 3A, display light incident upon screen layer 215 is not collimated. This divergent light can result in angular brightness variations at different locations across screen layer 215. As illustrated in FIG. 3C, this deviation can be greatest around the perimeter of each image portion 250 defined by a given pixlet. Certain embodiments variously provide display screen illumination architectures that accommodate light or various brightness and/or color while providing a relatively uniform angular brightness across the screen.

An illumination architecture according to an embodiment includes a light transmission device, referred to you herein as a light transmission device (or alternatively, light transmission unit), coupled to receive light variously output from multiple illumination sources, the light transmission device to integrate (mix) such light and to direct at least a portion of the light toward a pixel array of a display system. Such light may be made available for use with additional optical components (included in or coupled to the illumination architecture) to illuminate a region of a display. As compared to conventional mechanisms, light integration with the illumination architecture may provide a space-efficient mechanism for improved brightness consistency and/or color point consistency in the displaying of an image.

Individual illumination sources in a conventional 2-dimensional array tend to show significant visual artifacts due to varying brightness and/or color point (e.g. where viewers perceive a difference between two cool white LEDs that differ in color temperature by several hundred degrees Kelvin). By mixing light from multiple illumination sources along a common optical path, certain embodiments provide an averaging of variations between individual illumination sources, resulting in a relatively uniform brightness and/or color over a large area of a display. A light transmission device may further serve as a shield structure in close proximity to protect a group of illumination sources from contact and/or contamination.

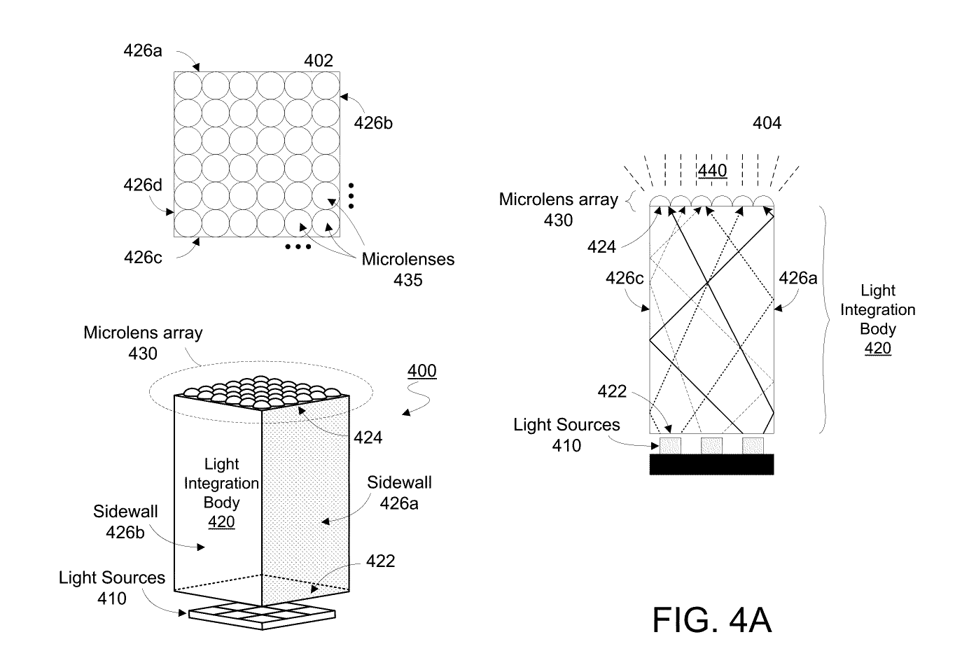

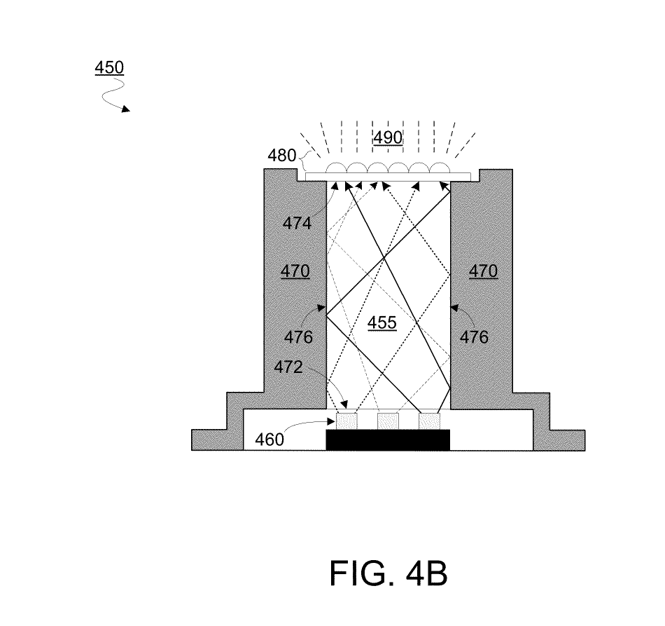

FIG. 4A illustrates features of a light transmission device 400 that may couple to, or include, a plurality of illumination sources (as represented by the illustrative light sources 410). Some or all of the multiple light sources 410 may output light that is white or nearly white, although certain embodiments are not limited in this regard. By way of illustration and not limitation, light sources 410 may alternatively or in addition comprise some combination of red lights, green lights and blue lights. In an embodiment, illumination sources of the illumination layer may be arranged to form one or more groups of illumination sources that are each to generate respective light to be received by a corresponding light transmission device. For example, light sources 410 may each generate a respective portion of light to be received by light transmission device 400.

Light transmission device 400 may include a light integration body 420 to integrate (mix) light variously generated by light sources 410. Light integration body 420 may comprise an integration rod portion disposed between a first end 422 of light integration body 420 and a second end 424 of light integration body 400. In the illustrative embodiment of FIG. 4A, light integration body 420 is a solid integration rod, top and bottom sides of which form, respectively, a first end 422 and a second end 424.

First end 422 and second end 424 may serve, respectively, as an input end and an output end of light integration body 420. Unless otherwise indicated herein, “input end” refers to that end of a light integration body through which light may be received by that light integration body. Similarly, “output end” refers to an end of a light integration structure through which at least some of such light may be output from that light integration body. As discussed herein, an end of the light integration structure may comprise a surface area of the light integration structure or, alternatively, an opening defined by the surface of the light integration structure. An input end and an output end may be directly opposite and/or parallel to one another, in some embodiments.

Light integration body 420 may comprise any of a variety of light transmissive materials such as one of those used in conventional optical technology. One example of such material is a transparent thermoplastic synthetic resin, formed by casting or molding, which has the clarity similar to that of a glass. A specific thermoplastic synthetic resin material having such properties is polymethyl methacrylate (PMMA) or polymethyl-2-methylpropanoate, which is the synthetic polymer of methyl methacrylate. This thermoplastic and transparent plastic is sold by various manufacturers under the trade names of PLEXIGLAS, PERSPEX, ACRYLITE, ACRYLPLAST, and LUCITE and is commonly called ACRYLIC GLASS or simply ACRYLIC.

In other embodiments, light integration body 420 may be formed of other clear, transparent materials such as polycarbonate, for example, as well as clear transparent glass. However, plastics and other synthetic materials have certain comparative advantages over glass—e.g. with respect to molding small mounting elements or other mechanical features.

As variously shown in detail views 402, 404, a length between ends 422, 424 of light integration body 420 allows for mixing of light from light sources 410 due at least in part to such light variously reflecting off of sidewalls 426a, 426b, 426c, 426d during transmission away from first end 422 and toward second end 424. In order to provide sufficient mixing of light, a light integration body may have an overall length between an input end and an output end, wherein the light integration body is to receive light through an end having at least a threshold dimension—e.g., relative to the overall length. By way of illustration and not limitation, a ratio of the length of the light integration body to a width (or depth, diameter, etc.) of an input end of the light integration body may be greater than four. In one embodiment, such a ratio is equal to or greater than five. For example, end 422 of light integration body 420 may be 1 mm wide, where the overall length of light integration body 420 between ends 422, 424 is at least 5 mm. However, light integration body 420 may include any of a variety of other dimensions—and/or any of a variety of other relationships between such dimensions—according to implementation-specific details of different embodiments. The particular proportions shown for light integration body 420 are merely illustrative, and are not limiting on certain embodiments.

Conventionally, the brightness and/or color uniformity of a display is controlled by software mechanisms. However, such software control is a subtractive solution—e.g., wherein various regions of a display can only be reduced in efficiency in order to provide image display uniformity at a lower brightness level. Moreover, in a conventional display that uses a 2-dimensional array of individual illumination sources, if one illumination source fails, it will produce a black (no light) region on the display. By contrast, certain embodiments combine the light from multiple illumination sources in a light integration structure. For example, transmission of light through light transmission device 400 may result in uniform illumination being available even in the event that one or more of light sources 410 fail. As a result, the loss of one or more of light sources 410 may be compensated for by increasing power to the remaining ones of light sources 410 such that noticeable effects to varying brightness and/or color are reduced.

A light transmission device may further comprise a microlens array to receive and direct integrated light at an output end of a light integration body. By way of illustration and not limitation, a microlens array 430 of light transmission device 400 may be coupled to or otherwise disposed at second end 424. The directing of integrated light 440 through and out from microlens array 430 may facilitate an improved image plane that pixels of a display layer (not shown) may avail of to project a displayed image. In some embodiments, microlens array 430 may project light toward a curved (non-planar) area of a display layer, allowing for improved efficiency and/or uniformity of the light projected onto such a curved area.

A microlens array may be molded onto or with an output end of the light integration body—e.g., where microlens array 430 is a molded feature that is integral to an end of a solid rod portion. Alternatively or in addition, a microlens array may be formed separately and subsequently attached to the light integration body. For example, microlens array 430 may be bonded to a surface of a solid light integration rod—e.g., with any of a variety of index matched adhesive materials used in conventional optical devices.

Microlens array 430 may include any of a variety of arrangements of microlenses. In one embodiment, microlens array 430 comprises at least five microlenses extending in sequence along a given dimension (e.g., row or column) of the array. For example, if microlens array 430 covers a 1 mm by 1 mm area, microlens array 430 may comprise a 5×5 array of twenty-five (25) microlenses having an average diameter that is each equal to or smaller than 200 microns. Microlenses of a microlens array may have any of a variety of shapes and/or arrangements relative to one another, according to different embodiments. For example, the microlenses may variously have circular, elliptical, square, rectangular, hexagonal and/or other individual shapes. Such microlenses may be arranged to form any of a variety of patterns—e.g., wherein adjacent microlenses do not allow for any interstitial gaps. An array of close-packed microlenses requires all light exiting the light integration body to pass through some microlens, which may prove to be comparatively effective at limiting optical artifacts in a resulting image display. Although microlens array 430 is shown in detail view 402 as including a 6×6 array of microlenses 435, any of a variety of other arrangements including fewer or more microlenses may be provided, according to different embodiments.

FIG. 4B illustrates elements of a light transmission device 450 according to another embodiment. Light transmission device may provide some or all of the light integration and directing functionality of light transmission device 400, for example.

In an embodiment, light transmission device 450 includes or couples to light sources 460 which, for example, have some or all of the features of light sources 410. A light integration body 470 of light transmission device 450 may be coupled to receive at an input end 472 light from light sources 460. Light integration body 470 may form sidewalls 476 of a cavity 455 that extends through light integration body 470. Although certain embodiments are not limited in this regard, sidewalls 476 may be coated with a metal or other light reflective material (e.g., any of a variety known in the art). Such a hollow type of light integration body may be comprised of a non-transparent material, such as a translucent plastic, a metal or the like. Light integration may be achieved at least in part by reflection of light off of sidewalls 476. Some or all of such integrated light may be transmitted to an output end 474 of light integration body 470.

In an embodiment, light transmission device 450 further comprises a microlens array 480 disposed at output end 474. Microlens array 480 may include a plurality of microlenses to receive at least a portion 490 of the integrated light and to variously direct such the light portion 490 toward pixels (not shown) such as those of a pixel array 230. For example, microlens array 480 may include a patterned plate and/or film disposed across an end of a hollow integration rod portion. In an embodiment, microlenses of microlens array 480 may be laser written on a piece of glass, which may be subsequently bonded to output end 474.

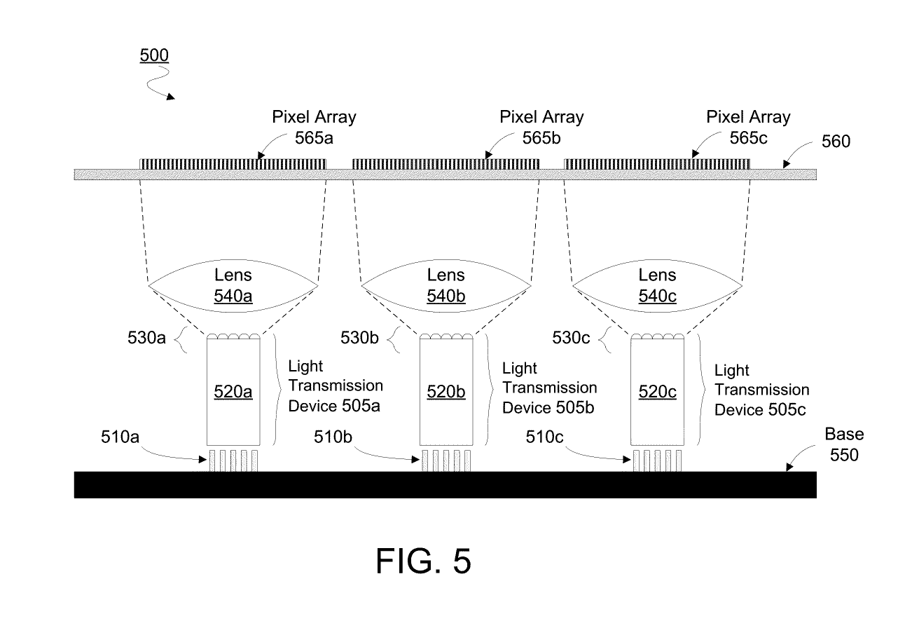

FIG. 5 illustrates elements of the system 500 for displaying an image according to an embodiment. System 500 may comprise some or all of the features of rear projection display 200, for example. In an embodiment, system 500 comprises a plurality of light transmission devices that, for example, variously provide functionality such as that discussed herein with respect to light transmission devices 400, 450.

By way of illustration and not limitation, system 500 may comprise an illumination layer including a plurality of light transmission devices 505a, 505b, 505c which each include or couple to a respective group of illumination sources (as represented by the illustrative illumination source groups 510a, 510b, 510c). Respective light integration bodies 520a, 520b, 520c of light transmission devices 505a, 505b, 505c may each receive and integrate light from a corresponding one of illumination source groups 510a, 510b, 510c. Such integrated light may then be output to respective microlens arrays 530a, 530b, 530c of light transmission bodies 505a, 505b, 505c.

Such microlens arrays may each facilitate a distribution of integrated light across a respective area of a display layer 560. For example, display layer 560 may comprise a plurality of pixel arrays 565a, 565b, 565c which are spaced apart from one another—e.g. to form an array of pixel arrays. In such an embodiment, integrated light variously directed through microlens arrays 530a, 530b, 530c to provide a wide area of illumination on respective lenses 540a, 54b, 540c. The illuminating light may be focused at least partially by respective lenses 540a, 540b, 540c to provide directed illumination of pixel arrays 565a, 5665b, 565c.

In some embodiments, control logic (not shown) may provide color and/or brightness regulation which is granular at the level of (e.g., specific to) an individual one of light transmission devices 505a-505c. Such device-specific regulation may allow for improved dynamic contrast and/or dynamic brightness control. By way of illustration and not limitation, adjusting a level of power being provided to illumination source group 505b may allow for local control of brightness being directed through to a particular region of the display layer—e.g., a region including pixel array 565b. This allows for the representation of highlighted (or light-emitting, etc.) objects in an image to be more clearly contrasted with other objects of the image that are shaded or otherwise dark. Accordingly, such devices may support an improved contrast ratio, as compared to that of conventional displays.

In some embodiments, light from a group of illumination sources may be integrated and distributed to multiple groups of pixels in a display layer—e.g., where such groups of pixels are spaced apart from one another. Integrated light may be output from only a single output end of a light integration body or, alternatively from multiple output ends of the light integration body. For example, a light integration body may comprise a plurality of integration rod portions forming a manifold of multiple output ends. Such multiple output ends may form a 2×2 array of output ends, a 3×3 array of output ends, or any of various other arrangements of output ends. Although certain embodiments are not limited in this regard, the one or more output ends of such a light integration body may have a total area equal to that of an input end of the light integration body. Multiple smaller components of the display layer may then be optically stitched together—e.g., insofar as they receive via the same light transmission device light having the same brightness and color.

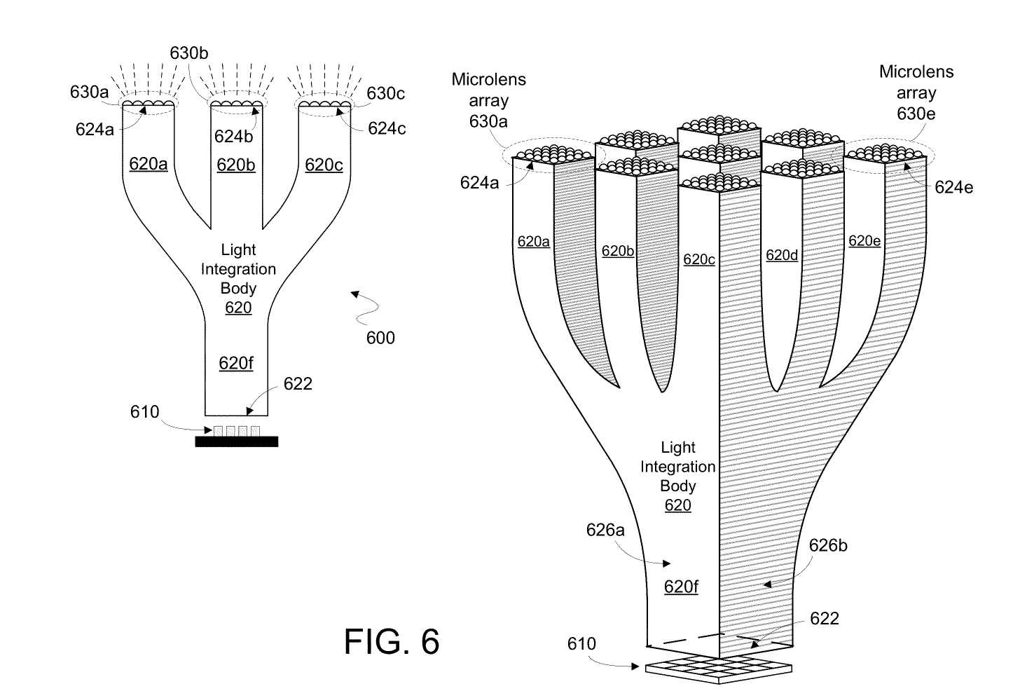

By way of illustration and not limitation, FIG. 6 illustrates elements of a light transmission device 600 according to another embodiment. Light transmission device may provide some or all of the functionality of one or light transmission devices 400, 450, for example. In an embodiment, light transmission device 600 may integrate light to be provided to pixels (not shown) such as those of a pixel array 230, display layer 560 or the like.

Light transmission device 600 may include or couple to light sources 610, where light generated by light sources 610 is to be received by a light integration body 620 at an input end 622. Light integration body 620 may comprise an integration rod portion 620f to provide a preliminary integration of light received via input end 622. A plurality of other integration rod portions of light integration body 620 may variously extend from integration rod portion 620f. Such a plurality of integration rod portions is represented in FIG. 6 as including integration rod portions 620a, 620b, 620c, 620d, 620e. Although certain embodiments are not limited in this regard, output ends of the plurality of integration rod portions may be positioned to support an array of microlens arrays. By way of illustration and not limitation, light transmission device 600 may include a 3×3 array of microlens arrays (e.g., including microlens arrays 630a, 630b, 630c, . . . , 630e) which are each located at a respective one of output ends 624a, 624b, 624c, . . . , 624e. Each of the other integration rod portions may receive a respective portion of light integrated by integration rod portion 620f, and provide further integration of such portion of light while it is being directed toward a corresponding microlens array of the array (or manifold) of microlens arrays. In an alternate embodiment, light transmission device 600 may provide for light integration within a cavity formed by interior sidewalls of light integration body 620.

In an illustrative scenario according to one embodiment, a 32-inch display may comprise and array of pixel arrays—e.g. an arrangement of 144 pixel arrays arranged in a 16×9 configuration. Such an array of arrays may be backlit with 144 light transmission devices, each of which is dedicated to a different respective pixel array of the configuration. Alternatively, the display layer of such a display may comprise 1296 pixel arrays arranged in a 48×27 configuration. In such an embodiment, it may be impractical to provide 1296 individual light transmission devices each for a different respective pixel array of such a configuration. Accordingly, certain embodiments variously mitigate this problem by providing one or more light transmission devices which he could comprise a respective manifold of multiple microlens arrays, each microlens array of the manifold direct light towards a respective pixel array of the 40×27 configuration. Such a light transmission device may be able to provide consistent brightness and/or color to any of the variety of n-by-m array of pixel arrays (wherein one or both of m and n is greater than 1) of the configuration. In this example embodiment, the integer m may be equal, or different than, the integer n.

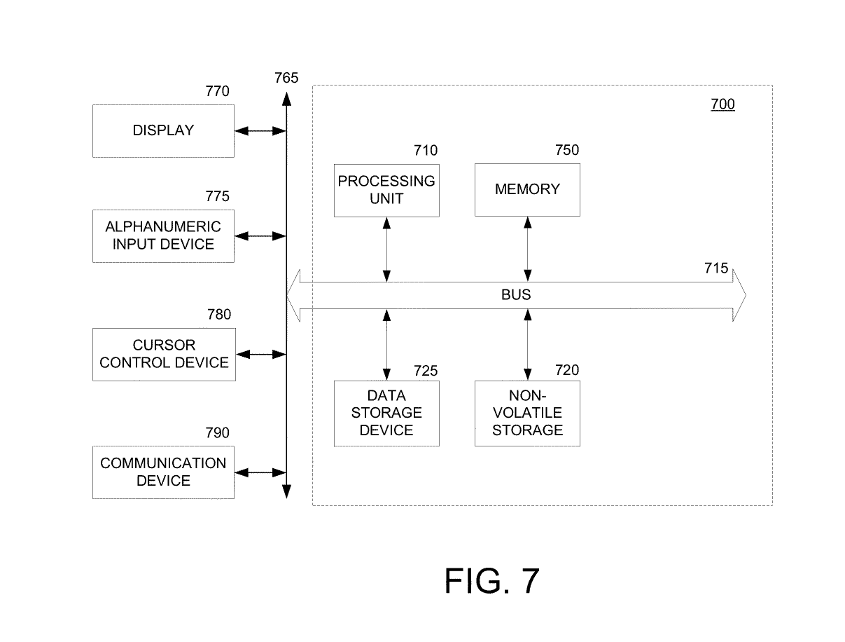

FIG. 7 is an illustration of components of a device to utilize an embodiment of the disclosure. Platform 700 may be used for one of the tileable display panels described above. Platform 700 may also be used to provide video processing, power, display control computing ability (e.g., decoding and converting content) and/or connectivity (e.g., network connectivity) to a device including a tileable display panel. For example, platform 700 may comprise display driver components communicatively coupled to the above described tileable display panel. Platform 700 may be used to decode/convert content into video signal formats such as high definition multimedia interface (HDMI), component, composite digital visual interface (DVI), video graphics adapter (VGA), Syndicat des Constructeurs d'Appareils Radiorecepteurs et Televiseursor (SCART), or other video signal formats.

Platform 700 as illustrated includes bus or other internal communication means 715 for communicating information, and processor 710 coupled to bus 715 for processing information. The platform further comprises random access memory (RAM) or other volatile storage device 750 (alternatively referred to herein as main memory), coupled to bus 715 for storing information and instructions to be executed by processor 710. Main memory 750 also may be used for storing temporary variables or other intermediate information during execution of instructions by processor 710. Platform 700 also comprises read only memory (ROM) and/or static storage device 720 coupled to bus 715 for storing static information and instructions for processor 710, and data storage device 725 such as a magnetic disk, optical disk and its corresponding disk drive, or a portable storage device (e.g., a universal serial bus (USB) flash drive, a Secure Digital (SD) card). Data storage device 725 is coupled to bus 715 for storing information and instructions.

Platform 700 may further be coupled to display device 770, such as a cathode ray tube (CRT) or an LCD coupled to bus 715 through bus 765 for displaying information to a computer user. In embodiments where platform 700 provides computing ability and connectivity to a created and installed display device, display device 770 may comprise any of the tileable display panels described above. Alphanumeric input device 775, including alphanumeric and other keys, may also be coupled to bus 715 through bus 765 (e.g., via infrared (IR) or radio frequency (RF) signals) for communicating information and command selections to processor 710. An additional user input device is cursor control device 780, such as a mouse, a trackball, stylus, or cursor direction keys coupled to bus 715 through bus 765 for communicating direction information and command selections to processor 710, and for controlling cursor movement on display device 770. In embodiments utilizing a touch-screen interface, it is understood that display 770, input device 775 and cursor control device 780 may all be integrated into a touch-screen unit.

Another device, which may optionally be coupled to platform 700, is a communication device 790 for accessing other nodes of a distributed system via a network. Communication device 790 may include any of a number of commercially available networking peripheral devices such as those used for coupling to an Ethernet, token ring, Internet, or wide area network. Communication device 790 may further be a null-modem connection, or any other mechanism that provides connectivity between computer system 700 and the outside world. Note that any or all of the components of this system illustrated in FIG. 7 and associated hardware may be used in various embodiments of the disclosure.

It will be appreciated by those of ordinary skill in the art that any configuration of the system illustrated in FIG. 7 may be used for various purposes according to the particular implementation. The control logic or software implementing embodiments of the disclosure can be stored in main memory 750, mass storage device 725, or other storage medium locally or remotely accessible to processor 710.

It will be apparent to those of ordinary skill in the art that any system, method, and process to capture media data as described herein can be implemented as software stored in main memory 750 or read only memory 720 and executed by processor 710. This control logic or software may also be resident on an article of manufacture comprising a computer readable storage medium having computer readable program code embodied therein and being readable the mass storage device 725 and for causing processor 710 to operate in accordance with the methods and teachings herein.

Embodiments of the disclosure may also be embodied in a handheld or portable device containing a subset of the computer hardware components described above. For example, the handheld device may be configured to contain only the bus 715, the processor 710, and memory 750 and/or 725. The handheld device may also be configured to include a set of buttons or input signaling components with which a user may select from a set of available options. The handheld device may also be configured to include an output apparatus such as a LCD or display element matrix for displaying information to a user of the handheld device. Conventional methods may be used to implement such a handheld device. The implementation of the disclosure for such a device would be apparent to one of ordinary skill in the art given the disclosure as provided herein.

Embodiments of the disclosure may also be embodied in a special purpose appliance including a subset of the computer hardware components described above. For example, the appliance may include processor 710, data storage device 725, bus 715, and memory 750, and only rudimentary communications mechanisms, such as a small touch-screen that permits the user to communicate in a basic manner with the device. In general, the more special-purpose the device is, the fewer of the elements need be present for the device to function.

Techniques and architectures for displaying an image are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A display device comprising:
a display layer comprising a plurality of pixels;
an illumination layer including:
a plurality of light sources each to generate a respective portion of first light; and
a light transmission unit including:
a light integration body comprising a first integration rod portion disposed between a first end of the light integration body and a second end of the light integration body, the first end to receive the first light, the first integration rod portion to mix the first light and to direct at least a portion of the first light toward the second end; and
a first microlens array disposed at the second end, the first microlens array including a plurality of microlenses to receive the portion of the first light and to direct the portion of the first light from the light transmission unit toward the plurality of pixels.

2. The display device of claim 1, wherein the light integration body is a solid light integration rod.

3. The display device of claim 1, wherein a surface of the light integration rod forms sidewalls of a cavity which extends through the light integration body.

4. The display device of claim 1, the light integration body further comprising:
a plurality of integration rod portions each extending from the first integration rod portion, the plurality of integration rod portions including a second integration rod portion defining the second end; and
one or more other microlens arrays each disposed at a respective end of one of the plurality of integration rod portions, wherein, for each of the plurality of integration rods portions other than the second integration rod portion, an end of the integration rod portion is coupled to a respective one of the one or more other microlens arrays.

5. The display device of claim 4, wherein the plurality of pixels are arranged as a plurality of pixel arrays, wherein the first microlens array and the one or more additional arrays are each to direct light to a different respective one of the plurality of pixel arrays.

6. The display device of claim 1, wherein a ratio of a length of the light integration body to a dimension of the first end is greater than four.

7. The display device of claim 6, wherein the ratio is equal to or greater than five.

8. The display device of claim 1, the illumination layer further comprising one or more groups of light sources and one or more other light transmission devices each to integrated respective light of a corresponding one of the one or more groups of light sources.

9. The display device of claim 1, wherein the first microlens array comprises a five-by-five array of microlenses.

10. A tileable display panel, comprising:
a screen layer upon which a unified image is projected from a backside;
a display layer including a plurality of pixel arrays separated from each other by spacing regions, the plurality of pixel arrays including a first pixel array; and
an illumination layer including:
a plurality of light sources each to generate a respective portion of first light; and
a light transmission unit including:
a light integration body comprising a first integration rod portion disposed between a first end of the light integration body and a second end of the light integration body, the first end to receive the first light, the first integration rod portion to mix the first light and to direct at least a portion of the first light toward the second end; and
a first microlens array disposed at the second end, the first microlens array including a plurality of microlenses to receive the portion of the first light and to direct the portion of the first light from the light transmission unit toward the first pixel array;
wherein each of the pixel arrays is positioned to be illuminated by light from the illumination layer and to project a magnified image sub-portion onto the backside of the screen layer such that the magnified image sub-portions collectively blend together to form the unified image which covers the spacing regions on the display layer.

11. The tileable display panel of claim 10, wherein a surface of the light integration body forms sidewalls of a cavity which extends through the light integration body.

12. The tileable display panel of claim 10, the light integration body further comprising:
a plurality of integration rod portions each extending from the first integration rod portion, the plurality of integration rod portions including a second integration rod portion defining the second end; and
one or more other microlens arrays each disposed at a respective end of one of the plurality of integration rod portions, wherein, for each of the plurality of integration rods portions other than the second integration rod portion, an end of the integration rod portion is coupled to a respective one of the one or more other microlens arrays.

13. The tileable display panel of claim 10, wherein a ratio of a length of the light integration body to a dimension of the first end is greater than four.

14. The tileable display panel of claim 10, the illumination layer further comprising one or more groups of light sources and one or more other light transmission devices each to integrated respective light of a corresponding one of the one or more groups of light sources.

15. The tileable display panel of claim 10, wherein the first microlens array comprises a five-by-five array of microlenses.

16. The tileable display panel of claim 10, further comprising a lens disposed between the first microlens array and the display layer, wherein the first microlens array to direct light toward the lens.

17. A display system, comprising:
a plurality of display panels each housed within a bezel that permits the display panels to be aligned relative to each other and communicatively coupled to collectively display a multi-panel unified image across the display panels, wherein each of the display panels includes:
a screen layer upon which a unified image is projected from a backside;
a display layer including a plurality of pixel arrays separated from each other by spacing regions, the plurality of pixel arrays including a first pixel array; and
an illumination layer including:
a plurality of light sources each to generate a respective portion of first light; and
a light transmission unit including:
a light integration body comprising a first integration rod portion disposed between a first end of the light integration body and a second end of the light integration body, the first end to receive the first light, the first integration rod portion to mix the first light and to direct at least a portion of the first light toward the second end; and
a first microlens array disposed at the second end, the first microlens array including a plurality of microlenses to receive the portion of the first light and to direct the portion of the first light from the light transmission unit toward the first pixel array;
wherein each of the pixel arrays is positioned to be illuminated by the light from the illumination layer and to project a magnified image sub-portion onto the backside of the screen layer such that the magnified image sub-portions collectively blend together to form the unified image which covers the spacing regions on the display layer.

18. The display system of claim 17, wherein a surface of the light integration rod forms sidewalls of a cavity which extends through the light integration body.

19. The display system of claim 17, the light integration body further comprising:
a plurality of integration rod portions each extending from the first integration rod portion, the plurality of integration rod portions including a second integration rod portion defining the second end; and
one or more other microlens arrays each disposed at a respective end of one of the plurality of integration rod portions, wherein, for each of the plurality of integration rods portions other than the second integration rod portion, an end of the integration rod portion is coupled to a respective one of the one or more other microlens arrays.

20. The display system of claim 17, wherein a ratio of a length of the light integration body to a dimension of the first end is greater than four.

21. The display system of claim 20, wherein the ratio is equal to or greater than five.

22. The display system of claim 17, the illumination layer further comprising one or more groups of light sources and one or more other light transmission devices each to integrated respective light of a corresponding one of the one or more groups of light sources.

23. The display system of claim 17, wherein the first microlens array comprises a five-by-five array of microlenses.

24. The display system of claim 17, further comprising a lens disposed between the first microlens array and the display layer, wherein the first microlens array to direct light toward the lens.
